(19) United States
(12) Patent Application Publication
(10) Pub. No.: US 2008/0182646 A1
(43) Pub. Date: Jul. 31, 2008

(54) SLOT MACHINE INCLUDING A PLURALITY OF SLOT GAME AREAS AND CONTROLLING METHOD THEREOF

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/017,592

(22) Filed: Jan. 22, 2008

(30) Foreign Application Priority Data
Jan. 23, 2007 (JP) JP2007-013114

(51) Int. Cl. A63F 13/00

(52) U.S. Cl. 463/20

(57) ABSTRACT

A slot machine includes a plurality of slot game areas in each of which a slot game can be individually played and allows two or more slot games to be simultaneously played in one play session by betting medals on the two or more slot games in the slot game areas. In the slot machine, a slot game is executed in each of activated ones of the slot game areas on a liquid crystal display. When at least one combination of symbols leading to a payout is established as an outcome of each of the slot games, some of credits to be paid out are accumulated as a special payout. Thereafter, a special slot game is set to be executable when a predetermined condition is met, and a special payout is provided when a specific combination is established as an outcome of the special slot game.

### CROSS REFERENCE TO RELATED APPLICATIONS

This application is based upon and claims the benefit of priority from the prior Japanese Patent Application No. 2007-013114, filed on Jan. 23, 2007, the entire contents of which are incorporated herein by reference.

### BACKGROUND OF THE INVENTION

1. Field of the Invention

The present invention relates to a slot machine and a method for controlling the slot machine.

2. Description of the Related Art

In a relevant slot machine, when a player operates a start button after inserting a predetermined number of medals from a medal insertion slot, a plurality of (for example, 3) reels on each of which a plurality of symbols are drawn are individually rotated. Then, the reels are stopped after a predetermined period of time. In this event, when symbols that form a winning combination are stopped on a preset payline or when a predetermined number of scatter symbols are stopped, a payout corresponding to the number of inserted medals is provided.

Meanwhile, the following is disclosed in U.S. Pat. No. 6,855,052. Specifically, in the case where symbols displayed on reels when the reels are stopped form a preset combination, a plurality of wheels provided above the reels sequentially start spinning and are subsequently stopped. Thereafter, when the outcome of a stop of a wheel satisfies a predetermined stop position, a large number of medals are paid out.

### SUMMARY OF THE INVENTION

The present invention was made to solve the conventional problems described above. It is an object of the present invention to provide a slot machine having new entertainment properties and a method for controlling the slot machine.

A first aspect of the present invention is a slot machine comprising: a display adapted to display a plurality of symbol matrices including a plurality of symbols arranged in the symbol matrices; and a controller configured to execute a slot game in each of the plurality of symbol matrices, the slot game in which whether credits are to be paid out or not is determined according to an arrangement determined by rearranging the plurality of symbols arranged in the symbol matrix, accumulate, as special credits, some of the credits to be paid out when a payout of credits is determined in the slot game, start a special slot game for paying out the special credits at a predetermined timing, and pay out the special credits when an arrangement of the symbols leading to a payout of the special credits is established in the special slot game.

According to the first aspect of the present invention, a slot game is designed to determine whether or not to pay out credits based on an arrangement of a plurality of symbols determined by rearranging the symbols arranged in a symbol matrix. In addition, a slot game is executed in each of the plurality of symbol matrices. Thereafter, when a payout of credits is determined in the slot game, some of the credits to be paid out are accumulated as special credits. Subsequently, a special slot game for paying out the special credits is started at a predetermined timing. When an arrangement of the symbols leading to a payout of the special credits is established in the special slot game, the special credits are paid out.

Accordingly, it is possible to provide new entertainment properties that allow a player to have expectations as to whether or not the arrangement of the symbols leading to a payout of the special credits is established in the special slot game. The above configuration is also very effective in enhancing the player's motivation to play the game.

A second aspect of the present invention is a slot machine comprising: a display adapted to display a plurality of symbol matrices including a plurality of symbols arranged in the symbol matrices; and a controller configured to execute a slot game in each of the plurality of symbol matrices, the slot game in which whether credits are to be paid out or not is determined according to an arrangement determined by rearranging the plurality of symbols arranged in the symbol matrix, accumulate, as special credits, some of the credits to be paid out when a payout of credits is determined in the slot game, start a special slot game for paying out the special credits at a predetermined timing, pay out the special credits when an arrangement of the symbols leading to a payout of the special credits is established in the special slot game, and carry the special credits over into the next-occurring special slot game, when the arrangement of the symbols leading to a payout of the special credits is not established in the current special slot game.

According to the second aspect of the present invention, the slot game is designed to determine whether or not to pay out credits based on an arrangement of a plurality of symbols determined by rearranging the symbols arranged in the symbol matrix. In addition, a slot game is executed in each of the plurality of symbol matrices. Thereafter, when a payout of credits is determined in the slot game, some of the credits to be paid out are accumulated as special credits. Subsequently, a special slot game for paying out the special credits is started at a predetermined timing. When an arrangement of the symbols leading to a payout of the special credits is established in the special slot game, the special credits are paid out. Meanwhile, when the arrangement of the symbols leading to a payout of the special credits is not established, the special credits are carried over to the next special slot game to occur.

Accordingly, when the arrangement of the symbols leading to a payout of the special credits is not established in the special slot game, the special credits are carried over to the next special slot game to occur and, consequently, an amount of the special credits to be paid out in the next special slot game is increased. Thus, it is possible to further heighten the player's expectations for the special slot game.

A third aspect of the present invention is a slot machine comprising: a display adapted to display a plurality of symbol matrices including a plurality of symbols arranged in the symbol matrices; and a controller configured to execute a slot game in each of the plurality of symbol matrices, the slot game in which whether credits are to be paid out or not is determined according to an arrangement determined by rearranging the plurality of symbols arranged in the symbol matrix, accumulate, as special credits, some of the credits to be paid out when a payout of credits is determined in the slot game, start a special slot game for paying out the special credits at a predetermined timing, pay out the special credits when an arrangement of the symbols leading to a payout of the special credits is established in the special slot game, and display a total number of the special credits on the display when the special slot game is started.

According to the third aspect of the invention, a slot game is designed to determine whether or not to pay out credits based on an arrangement of a plurality of symbols determined by rearranging the symbols arranged in the symbol matrix. In addition, a slot game is executed in each of the plurality of symbol matrices. Thereafter, when a payout of credits is determined in the slot game, some of the credits to be paid out are accumulated as special credits. Subsequently, a special slot game for paying out the special credits is started at a predetermined timing. When an arrangement of the symbols leading to a payout of the special credits is established in the special slot game, the special credits are paid out. When the special slot game is started, the total number of the special credits is displayed on a display.

Therefore, when the special slot game is started, the player can know the total number of the special credits. Thus, it is possible to further heighten the player's expectations for the special slot game.

The controller may be configured to start the special slot game when the symbols are rearranged in a specific combination in the symbol matrix in which the last slot game is executed, among the plurality of symbol matrices.

According to the above configuration, start of a special slot game is triggered by a specific combination of the plurality of symbols determined by rearranging the symbols arranged in the symbol matrix in which the last slot game is executed among the plurality of symbol matrices.

Therefore, it is possible to further heighten the player's expectations for the special slot game when the special slot game is started.

A fourth aspect of the present invention is a method for controlling a slot machine, comprising the steps of: executing a slot game in each of a plurality of symbol matrices, the slot game in which whether credits are to be paid out or not is determined according to an arrangement determined by rearranging the plurality of symbols arranged in the symbol matrix; accumulating, as special credits, some of the credits to be paid out when a payout of credits is determined in the slot game, starting a special slot game for paying out the special credits at a predetermined timing, and paying out the special credits when an arrangement of the symbols leading to a payout of the special credits is established in the special slot game.

According to the fourth aspect of the present invention, a slot game is designed to determine whether or not to pay out credits based on an arrangement of a plurality of symbols determined by rearranging the symbols arranged in a symbol matrix. In addition, a slot game is executed in each of the plurality of symbol matrices. Thereafter, when a payout of credits is determined in the slot game, some of the credits to be paid out are accumulated as special credits. Subsequently, a special slot game for paying out the special credits is started at a predetermined timing. When an arrangement of the symbols leading to a payout of the special credits is established in the special slot game, the special credits are paid out.

Accordingly, it is possible to provide new entertainment properties that allow a player to have expectations as to whether or not the arrangement of the symbols leading to a payout of the special credits is established in the special slot game. The above configuration is also very effective in enhancing the player's motivation to play the game.

A fifth aspect of the present invention is a method for controlling a slot machine, comprising the steps of: executing a slot game in each of a plurality of symbol matrices, the slot game in which whether credits are to be paid out or not is determined according to an arrangement determined by rearranging the plurality of symbols arranged in the symbol matrix; accumulating, as special credits, some of the credits to be paid out when a payout of credits is determined in the slot game, starting a special slot game for paying out the special credits at a predetermined timing, paying out the special credits when an arrangement of the symbols leading to a payout of the special credits is established in the special slot game, and carrying the special credits over into the next-occuring special slot game, when the arrangement of the symbols leading to a payout of the special credits is not established in the current special slot game.

According to the fifth aspect of the present invention, the slot game is designed to determine whether or not to pay out credits based on an arrangement of a plurality of symbols determined by rearranging the symbols arranged in the symbol matrix. In addition, a slot game is executed in each of the plurality of symbol matrices. Thereafter, when a payout of credits is determined in the slot game, some of the credits to be paid out are accumulated as special credits. Subsequently, a special slot game for paying out the special credits is started at a predetermined timing. When an arrangement of the symbols leading to a payout of the special credits is established in the special slot game, the special credits are paid out. Meanwhile, when the arrangement of the symbols leading to a payout of the special credits is not established, the special credits are carried over to the next special slot game to occur.

Accordingly, when the arrangement of the symbols leading to a payout of the special credits is not established in the special slot game, the special credits are carried over to the next special slot game to occur and, consequently, an amount of the special credits to be paid out in the next special slot game is increased. Thus, it is possible to further heighten the player's expectations for the special slot game.

A sixth aspect of the present invention is a method for controlling a slot machine, comprising the steps of executing a slot game in each of a plurality of symbol matrices, the slot game in which whether credits are to be paid out or not is determined according to an arrangement determined by rearranging the plurality of symbols arranged in the symbol matrix; accumulating, as special credits, some of the credits to be paid out when a payout of credits is determined in the slot game, starting a special slot game for paying out the special credits at a predetermined timing, displaying a total number of the special credits on the display when the special slot game is started, and paying out the special credits when an arrangement of the symbols leading to a payout of the special credits is established in the special slot game.

According to the sixth aspect of the invention, a slot game is designed to determine whether or not to pay out credits based on an arrangement of a plurality of symbols determined by rearranging the symbols arranged in the symbol matrix. In addition, a slot game is executed in each of the plurality of symbol matrices. Thereafter, when a payout of credits is determined in the slot game, some of the credits to be paid out are accumulated as special credits. Subsequently, a special slot game for paying out the special credits is started at a predetermined timing. When an arrangement of the symbols leading to a payout of the special credits is established in the special slot game, the special credits are paid out. When the special slot game is started, the total number of the special credits is displayed on a display.

Therefore, when the special slot game is started, the player can know the total number of the special credits. Thus, it is possible to further heighten the player's expectations for the special slot game.

The method may further comprise the step of starting the special slot game when the symbols are rearranged in a specific combination in the symbol matrix in which the last slot game is executed, among the plurality of symbol matrices.

According to the above configuration, start of a special slot game is triggered by a specific combination of the plurality of symbols determined by rearranging the symbols arranged in the symbol matrix in which the last slot game is executed among the plurality of symbol matrices.

Therefore, it is possible to further heighten the player's expectations for the special slot game when the special slot game is started.

### BRIEF DESCRIPTION OF THE DRAWINGS

FIG. 1A is an explanatory view showing a display screen example on an upper display for explaining a feature of a slot machine according to an embodiment of the present invention, and FIG. 1B is an explanatory view showing a display screen example on a liquid crystal display for similarly explaining a feature of the slot machine.

FIG. 2 is a perspective view of the slot machine according to the embodiment of the present invention.

FIG. 3 is a block diagram showing a control circuit in the slot machine according to the embodiment of the present invention.

FIG. 4 is a flowchart showing a procedure executed by the slot machine according to the embodiment of the present invention.

FIG. 5 is a flowchart showing a procedure executed by the slot machine according to the embodiment of the present invention.

FIG. 6 is a flowchart showing a procedure executed by the slot machine according to the embodiment of the present invention.

FIG. 7 is a flowchart showing a procedure executed by the slot machine according to the embodiment of the present invention.

FIG. 8 is a flowchart showing a procedure executed by the slot machine according to the embodiment of the present invention.

FIG. 9 is an explanatory view showing each slot game area in the slot machine according to the embodiment of the present invention.

FIG. 10 is an explanatory view showing paylines in each slot game area in the slot machine according to the embodiment of the present invention.

FIG. 11 is an explanatory view showing relationships between combinations of symbols and payouts in the slot machine according to the embodiment of the present invention.

FIG. 12 is an explanatory view showing slot game areas in each of which a slot game is activated among the slot game areas displayed on the liquid crystal display in the slot machine according to the embodiment of the present invention.

FIG. 13 is an explanatory view showing a state where the slot games are started in the activated slot game areas among the slot game areas displayed on the liquid crystal display in the slot machine according to the embodiment of the present invention.

FIG. 14 is an explanatory view showing a state where the slot games are started in the activated slot game areas among the slot game areas displayed on the liquid crystal display in the slot machine according to the embodiment of the present invention.

FIG. 15A is an explanatory view showing a display screen example on the upper display for explaining the feature of the slot machine, and FIG. 15B is an explanatory view showing a display screen example on the liquid crystal display for similarly explaining the feature of the slot machine.

FIG. 16A is an explanatory view showing a display screen example on the upper display for explaining the feature of the slot machine, and FIG. 16B is an explanatory view showing a display screen example on the liquid crystal display for similarly explaining the feature of the slot machine.

### DETAILED DESCRIPTION OF THE EMBODIMENT

A slot machine to be described as an embodiment of the present invention has the following configuration. Specifically, a slot game is designed to determine whether or not to pay out credits based on an arrangement of the plurality of symbols determined by rearranging the symbols arranged in each of the plurality of symbol matrices, and the slot game is executed in each of a plurality of symbol matrices which are displayed on a display and which include a plurality of symbols arranged therein. Thereafter, when a payout of credits is determined in the slot game, some of the credits to be paid out are accumulated as special credits. Subsequently, a special slot game for paying out the special credits is started at a predetermined timing. In addition, in the slot machine to be described as the embodiment of the present invention, when an arrangement of the symbols leading to a payout of the special credits is established in the special slot game, the special credits are paid out.

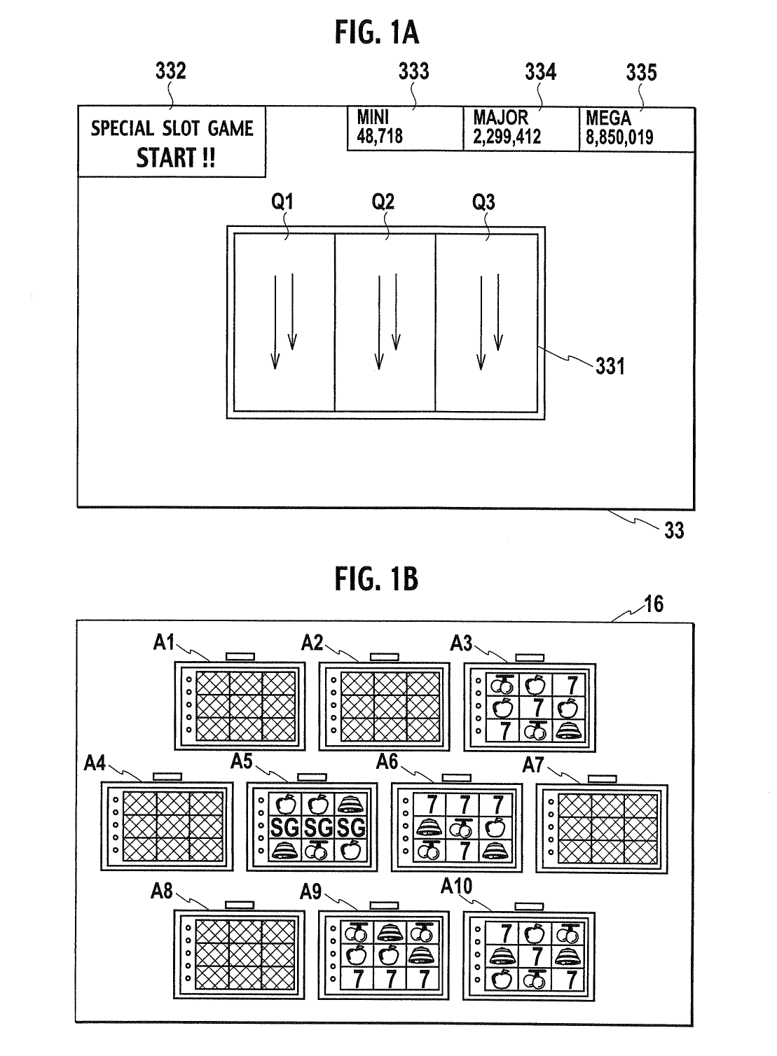

With reference to the drawings, features of the embodiment of the present invention will be described below. FIG. 1A shows an example of a display screen displayed on an upper display in the slot machine according to the embodiment of the present invention. FIG. 1B shows an example of a display screen displayed on a liquid crystal display in the slot machine according to the embodiment of the present invention. As shown in FIG. 1B, ten slot game areas A1 to A10 are provided in a liquid crystal display 16. In each of the slot game areas A1 to A10, a slot game can be executed.

Specifically, in each of the slot game areas A1 to A10, 3 rows×3 columns, a total of 9 display regions are provided. When a bet is made by inserting medals or pressing a BET switch 25 and a start switch 27 is subsequently pressed, the following slot game is executed. Specifically, symbols displayed in the display regions in 3 rows×3 columns are scrolled and the scrolling symbols are stopped in the respective display regions. Here, stops of the scrolling symbols in a new arrangement are referred to as a “rearrangement”.

In the slot game corresponding to each of the slot game areas A1 to A10, credits equivalent to a maximum of 3 medals, for example, can be bet. In each slot game, paylines are increased as the number of bets is increased.

In a slot machine 10, when medals are inserted from a medal insertion slot 21 provided below the liquid crystal display 16 or when the BET switch 25 is pressed, credits are sequentially bet on the ten slot game areas A1 to A10. In this event, a user may arbitrarily specify at least one of the slot game areas A1 to A10 on which the credits are bet, i.e., at least one of the slot game areas A1 to A10 in which the slot games start to be executed in a state where the credits are bet. Alternatively, the slot games may be automatically executed in numerical order of the slot game areas A1 to A10 in which the slot games are set to be executable. In the case where the player is allowed to specify the slot game area to start a slot game, the player can specify the slot game area by touching one of the slot game areas A1 to A10, for example. The operation of touching the slot game areas A1 to A10 by the player can be detected by a touch panel 69 provided on a surface of the liquid crystal display 16.

Therefore, for example, when the player inserts one medal from the medal insertion slot 21 after touching the slot game area A1, a credit equivalent to one medal is bet on the slot game area A1. When another medal is inserted, credits equivalent to two medals are bet on the slot game area A1.

Moreover, the following mode can also be employed. Specifically, when the player inserts medals after touching the at least one of the slot game areas A1 to A10 to specify, among the slot game areas A1 to A10, the slot game area to be executed in a state where credits are to be bet, the credits are randomly bet on the specified one of the slot game areas A1 to A10.

In the slot machine according to this embodiment, a slot game is executed in at least one slot game area in which the slot game is set to be executable among the slot game areas A1 to A10. Moreover, when at least one combination of symbols leading to a payout is established as an outcome of the slot game executed on the liquid crystal display 16, some of the credits to be paid out to the player are accumulated as special credits. Subsequently, a special slot game for paying out the special credits (hereinafter referred to as a special payout) is started at a predetermined timing. The special slot game will be described in detail later.

FIGS. 1A and 1B show a state where a symbol matrix for a special slot game appears on the upper display 33 after rearrangements of the symbols in the slot game areas A1 to A10 on the liquid crystal display 16 are finished and where scrolling of the symbols is started on the upper display 33. The upper display 33 has a special slot display part 331 having display regions Q1 to Q3 in which the symbols are scrolled, a message display part 332 for displaying information related to games and the like, a MINI display part 333 for displaying the number of credits for a special payout MINI, a MAJOR display part 334 for displaying the number of credits for a special payout MAJOR and a MEGA display part 335 for displaying the number of credits for a special payout MEGA. In the display screen example of the upper display 33 shown in FIG. 1A, a special slot game has just been started.

In the MINI display part 333, the number of credits accumulated so far for the special payout MINI is displayed. In the MAJOR display part 334, the number of credits accumulated so far for the special payout MAJOR is displayed. In the MEGA display part 335, the number of credits accumulated so far for the special payout MEGA is displayed.

Here, it is assumed to be a condition for starting the special slot game that “SG” (meaning a special game) symbols are lined up on any one of the horizontal lines in the slot game area A5, as an example. This is just an example and the condition for starting the special slot game is not particularly limited. When the lined-up “SG” symbols are displayed in the slot game area A5, execution of the special slot game has been determined inside the slot machine 10. On that basis, control is performed so as to leave the slot game area A5 and to line up the “SG” symbols on any of the horizontal lines in the slot game area A5 at the end. The player can receive a special payout when specific symbols are arranged in the special slot game, and the like. Moreover, when no payout is provided in this special slot game, the payout is carried over to the next special slot game to occur.

Each of the slot game areas A1, A2, A4, A7 and A8 indicates that a combination of symbols leading to a payout is not established after rearrangements are finished in the slot game. In this embodiment, those slot game areas are darkened, as an example. Moreover, each of the slot game areas A3, A6 and A9 indicates a state where the symbols are being scrolled and where a rearrangement thereof is not finished, in other words, a state where a slot game is being executed.

The upper display 33 displays the slot game area in which at least one combination of symbols leading to a payout is established as an outcome of the slot games executed on the liquid crystal display 16. In the slot game area A5 on the upper display 33, an “APPLE” symbol is arranged in a display region q11, a “SG” symbol is arranged in a display region q12, a “BELL” symbol is arranged in a display region q13, an “APPLE” symbol is arranged in a display region q21, a “SG” symbol is arranged in a display region q22, a “CHERRY” symbol is arranged in a display region q23, a “BELL” symbol is arranged in a display region q31, a “SG” symbol is arranged in a display region q32, and an “APPLE” symbol is arranged in a display region q33.

Moreover, in the slot game area A10 on the upper display 33, a “7” symbol is arranged in a display region q11, a “BELL” symbol is arranged in a display region q12, an “APPLE” symbol is arranged in a display region q13, an “APPLE” symbol is arranged in a display region q21, a “7” symbol is arranged in a display region q22, a “CHERRY” symbol is arranged in a display region q23, a “CHERRY” symbol is arranged in a display region q31, a “BELL” symbol is arranged in a display region q32, and a “7” symbol is arranged in a display region q33.

As described above, the slot machine described as the embodiment of the present invention can provide the following new entertainment properties. Specifically, when at least one combination of symbols leading to a payout is established as an outcome of the slot games each executed in one or more of the slot game areas A1 to A10 on the liquid crystal display 16, some of the credits to be paid out to the player are accumulated as a special payout. Subsequently, a special slot game for providing the special payout is started at a predetermined timing. Accordingly, it is possible to allow the player to further focus on the slot game.

The slot machine described as the embodiment of the present invention may have the following configuration. Specifically, areas in which slot games are activated among the slot game areas A1 to A10 and which displayed on the liquid crystal display 16 are determined according to the number of bets or the like, for example. Moreover, when a series of slot games in the slot game areas activated in one game session are finished, cumulative display on the upper display 33 is reset. The slot machine may also have a configuration in which, even if a series of slot games in the slot game areas activated in one game session are finished, cumulative display on the upper display 33 is not reset until the number of the slot game areas cumulatively displayed on the upper display 33 reaches a maximum value (5 in this embodiment).

Note that, in the above example, credits are bet on at least one of the slot game areas A1 to A10 by inserting medals. However, credits may be bet by use of coins, bills, bar-coded tickets and the like other than the medals. Moreover, the description was given by taking, as an example, the case where, in each slot game, stopped symbols are scrolled and the symbols are subsequently stopped again. However, the slot game is not limited to the case of scrolling the symbols. For example, the slot machine according to the present invention may have a configuration in which the symbols displayed (arranged) in the respective display regions are individually changed and new symbols are displayed (rearranged). Furthermore, in the above example, the maximum number of credits that can be bet on the respective slot game areas A1 to A10 is set to 3. However, the present invention is not limited thereto.

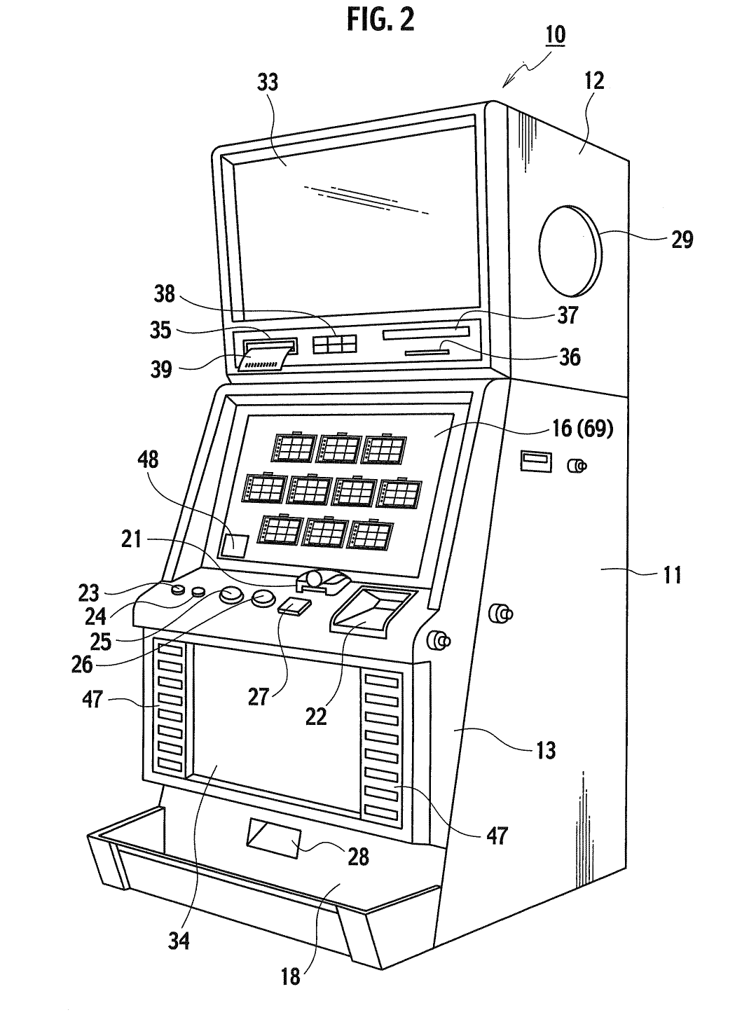

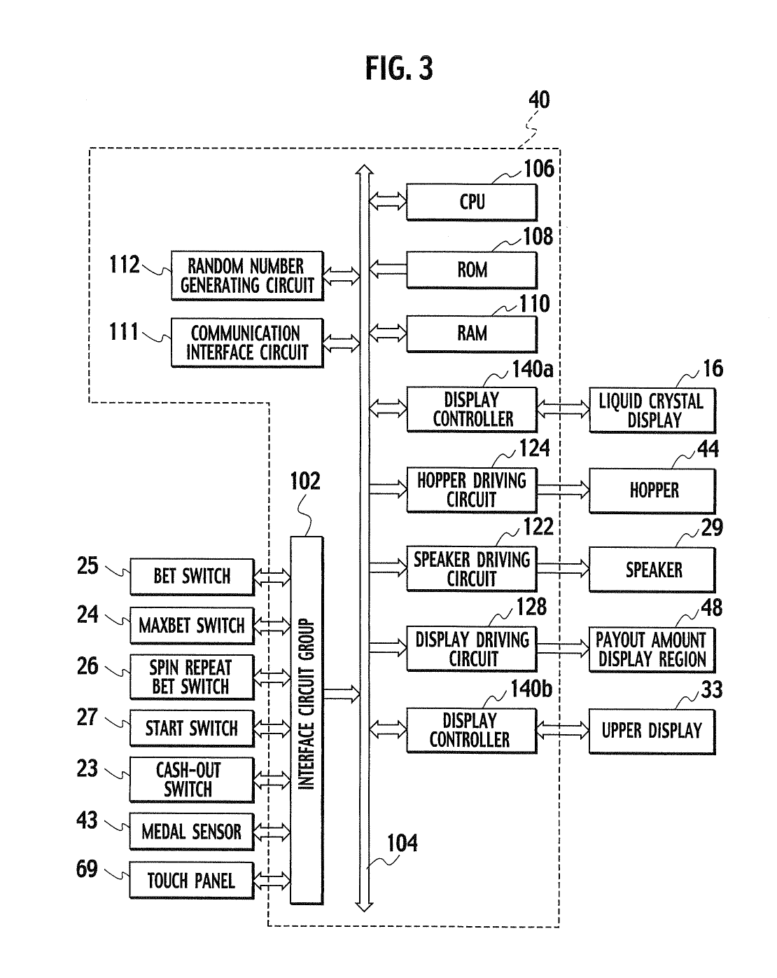

The slot machine according to the embodiment of the present invention will be described in detail below. FIG. 2 shows an external appearance of the slot machine according to the embodiment of the present invention. As shown in FIG. 2, the slot machine 10 includes a cabinet 11, a top box 12 provided on the cabinet 11 and a main door 13. The cabinet 11 has the liquid crystal display 16 provided on its surface facing the player. Moreover, inside the cabinet 11, various constituent members are provided, including a controller 40 (see FIG. 3) configured to electrically control the slot machine 10, a hopper 44 (see FIG. 3) configured to control insertion, storage and payouts of medals, and the like.

In this embodiment, medals are taken as an example of game media for supplying, to the slot machine 10, credits required to execute a game. However, the game media are not limited to the medals but may include, for example, coins, tokens, electronic money and valuable electronic information equivalent thereto.

The main door 13 is attached to the cabinet 11 so as to be openable and closable. In approximately the center of the main door 13, the liquid crystal display 16 equivalent to a first display as set forth in claims is provided. As described later, in the liquid crystal display 16, ten slot game areas A1 to A10 are provided. In the respective slot game areas A1 to A10, slot games are individually executed. In this embodiment, when a combination of symbols leading to a special slot game is established in a predetermined slot game area after the slot games are finished in each one or more of the slot game areas A1 to A10, the special slot game is executed on the upper display 33 to be described later. Note that, in this embodiment, the slot machine is configured to start the special slot game when a special combination is established in the slot game area A5.

In each of the slot game areas A1 to A10, 3 rows×3 columns, a total of 9 display regions are provided. In the respective display regions, various symbols are displayed. Specifically, when a slot game is started, symbols displayed (arranged) in the display regions are scrolled and then stopped (rearranged) after a predetermined period of time. In each of the slot game areas A1 to A10 in which the slot game is executed by betting at least one credit, a payout is determined (generated) according to a combination of symbols stopped in the respective display regions.

On the surface of the liquid crystal display 16, the touch panel 69 is provided. The touch panel 69 is vertically and horizontally divided into a plurality of regions in a matrix pattern. Some of the divided regions correspond to the ten slot game areas A1 to A10 displayed on the liquid crystal display 16, respectively. Specifically, when the player performs an operation of touching any one of the slot game areas A1 to A10, a position touched by the player can be identified by the touch panel 69.

Moreover, in a lower left area of the liquid crystal display 16, a payout amount display region 48 adapted to display an amount of payout is provided.

Below the liquid crystal display 16, provided are: the medal insertion slot 21 from which medals used for playing a game are inserted; and a bill validator 22 configured to validate whether or not bills are legitimate and to accept the legitimate bills. Moreover, in the vicinity of the medal insertion slot 21 and the bill validator 22, various operation switches are provided.

As the operation switches, a cash-out switch 23, a MAXBET switch 24, the BET switch 25, a spin repeat bet switch 26 and the start switch 27 are provided.

The BET switch 25 is a switch for determining the number of credits to be bet on at least one of the slot games to be respectively executed in the plurality of slot game areas A1 to A10. As described later, every time the BET switch 25 is pressed, a credit equivalent to 1 medal is bet on one of the slot game areas A1 to A10. In a slot game area on which any credit is bet among the slot game areas A1 to A10, a slot game is activated. In other words, the slot game area is set in a state that enables the slot game to be started. In the activated slot game area, a payout is determined when symbols are stopped in a predetermined combination on a payline.

The spin repeat bet switch 26 is a switch for starting a slot game in the previously bet one of the slot game areas A1 to A10 by betting credits on the previously bet one of the slot game areas A1 to A10 again without changing the number of credits bet on the slot game areas A1 to A10 by use of the BET switch 25 described above in the previous game.

The start switch 27 is a switch for starting a slot game in the slot game area in which the slot game is activated after a desired number of credits are bet on at least one of the plurality of slot game areas A1 to A10. When the start switch 27 is pressed after credits are bet by inserting medals from the medal insertion slot 21 or by pressing the BET switch 25, the slot game is started in the activated slot game area. Thereafter, when at least one combination of symbols leading to a payout is established, the payout is provided.

The cash-out switch 23 is a switch for paying out the inserted medals. The medals to be paid out are discharged from a medal payout opening 28 provided in a lower part of a front of the main door 13. The discharged medals are accumulated in a medal tray 18.

The MAXBET switch 24 is a switch for betting, in one operation, the maximum number of credits (for example, equivalent to 30 medals) that can be bet on one game.

On a lower front surface of the main door 13, a foot display 34 is provided, on which various images related to games run on the slot machine 10 are displayed. The images include characters of the slot machine 10 and the like.

On both sides of the foot display 34, lamps 47 are provided, which emit light based on illumination patterns which are respectively preset for plays performed on the slot machine 10. Below the foot display 34, the medal payout opening 28 is provided.

On the front surface of the top box 12, the upper display 33 is provided. The upper display 33 includes a display panel. When a combination of symbols leading to a special slot game is established in the slot game area A5 among the plurality of slot game areas, the special slot game is started.

In the top box 12, a speaker 29 is provided. Below the upper display 33, a ticket printer 35, a card reader 36, a data display 37 and a keypad 38 are provided. The ticket printer 35 prints out a bar-code on a ticket, the bar-code having coded data such as the number of credits, time and date and an identification number of the slot machine 10, and outputs the ticket as a bar-coded ticket 39.

The player can play a game on another slot machine by allowing the slot machine to read the bar-coded ticket 39 or change the bar-coded ticket 39 for bills and the like at a predetermined location in a game arcade (hall) (for example, a cashier in a casino).

The card reader 36 allows a smart card to be inserted thereinto, reads data from the inserted smart card and writes data into the smart card. The smart card is a card carried by the player and stores data for identifying the player, data on a history of games played by the player, and the like.

FIG. 3 shows the controller 40 provided in the slot machine 10 according to this embodiment and an electrical configuration of various devices connected to the controller 40. The controller 40 in the slot machine 10 shown in FIG. 3 is a microcomputer, including an interface circuit group 102, an input-output (I/O) bus 104, a central processing unit (CPU) 106, a read-only memory (ROM) 108, a random access memory (RAM) 110, a communication interface circuit 111, a random number generating circuit 112, a speaker driving circuit 122, a hopper driving circuit 124, a display driving circuit 128 and display controllers 140a and 140b. The liquid crystal display 16 is connected to the display controller 140a and the upper display 33 is connected to the display controller 140b.

The interface circuit group 102 is connected to the I/O bus 104. The I/O bus 104 inputs and outputs a data signal and an address signal to and from the CPU 106.

The start switch 27 is connected to the interface circuit group 102. A start signal outputted from the start switch 27 is transmitted, after converted into a predetermined signal by the interface circuit group 102, to the CPU 106 through the I/O bus 104.

The BET switch 25, the MAXBET switch 24, the spin repeat bet switch 26 and the cash-out switch 23 are further connected to the interface circuit group 102. Respective switching signals outputted from those switches 25, 24, 26 and 23 are supplied to the interface circuit group 102 and transmitted, after converted into predetermined signals by the interface circuit group 102, to the CPU 106 through the I/O bus 104.

In addition, a medal sensor 43 is connected to the interface circuit group 102. The medal sensor 43 is a sensor for detecting medals inserted from the medal insertion slot 21 and is provided in a medal insertion part of the medal insertion slot 21. A detection signal outputted from the medal sensor 43 is supplied to the interface circuit group 102 and transmitted, after converted into a predetermined signal by the interface circuit group 102, to the CPU 106 through the I/O bus 104.

Moreover, the touch panel 69 is connected to the interface circuit group 102. The touch panel 69 is for detecting an operation of touching, by the player, the ten slot game areas A1 to A10 displayed on the liquid crystal display 16. The touch panel 69 is provided on the surface of the liquid crystal display 16. A position detection signal outputted from the touch panel 69 is supplied to the interface circuit group 102 and transmitted, after converted into a predetermined signal by the interface circuit group 102, to the CPU 106 through the I/O bus 104.

The ROM 108 storing system programs and the RAM 110 for storing various data are connected to the I/O bus 104. The random number generating circuit 112, the communication interface circuit 111, the display controllers 140a and 140b, the hopper driving circuit 124, the speaker driving circuit 122 and the display driving circuit 128 are further connected to the I/O bus 104.

Upon receipt of a game start operation from the start switch 27, the CPU 106 executes a game by reading from the ROM 108 a game execution program among the system programs stored in the ROM 108. The game execution program is a program for allowing the CPU 106 to execute, through the display controllers 140a and 140b, a special slot game when a predetermined combination of symbols is established in the slot game area A5 among the slot game areas A1 to A10 displayed on the liquid crystal display 16.

To be more specific, the game execution program is a program for allowing the CPU 106 to execute the following slot game. Specifically, in each of the slot game areas in which the slot games are activated, among the slot game areas A1 to A10, symbols are scrolled and subsequently stopped. When the stopped symbols are rearranged in a predetermined combination on an activated payline, a payout corresponding to the combination is determined. Particularly, when a predetermined combination of symbols is established in the slot game area A5, a special slot game is executed. Furthermore, a special payout is provided according to an outcome of the special slot game.

The CPU 106 accumulates the credits for three kinds of special payouts prepared to be provided in the special slot game that is the feature of this embodiment. When at least one combination of symbols leading to a payout is established in any of the slot game areas A1 to A10 displayed on the liquid crystal display 16, the CPU 106 accumulates some of the thus determined credits to be paid out to the player, as a special payout. Thereafter, the CPU 106 starts a special slot game for paying out the special credits at a predetermined timing. For a special payout “MEGA”, the CPU 106 stores, in the RAM 110, 0.15% of the credits to be paid out when at least one combination of symbols leading to a payout is established in any of all the ten slot game areas. For a special payout “MAJOR”, the CPU 106 stores, in the RAM 110, 0.20% of the credits to be paid out when at least one combination of symbols leading to a payout is established in any of all the ten slot game areas. For a special payout “MINI”, the CPU 106 stores, in the RAM 110, 0.30% of the credits to be paid out when at least one combination of symbols leading to a payout is established in any of all the ten slot game areas. Here, the proportions of the credits to be stored in the RAM 110 are not limited to the values described above but may vary from one slot machine to another.

The amount of each of the special payouts stored in the RAM 110 may be set to be reset to 0 when the player loses the special slot game. On the other hand, in the case where the amount of the special payout is set not to be reset, the player can possibly obtain the credits accumulated by the previous player. Thus, it is possible to heighten the player's expectations.

When execution of the special slot game is determined, the CPU 106 performs lottery of random numbers for determining MINI, MAJOR, MEGA or a dummy (the dummy meaning that no payout is provided in the special slot game).

The communication interface circuit 111 is connected to an arcade server (a hall server) and the like and transmits to the arcade server data on a history of plays executed in the slot machine 10 and the like. Moreover, the communication interface circuit 111 receives various data transmitted from the arcade server.

The random number generating circuit 112 generates a random number for determining whether or not to generate a combination of symbols leading to a payout in the slot game activated in at least one of the slot game areas A1 to A10. In addition, the random number generating circuit 112 generates a random number for determining MINI, MAJOR, MEGA or a dummy in the special slot game.

The display driving circuit 128 performs control of displaying an amount of payout on the payout amount display region 48 set in the lower left area of the liquid crystal display 16.

The speaker driving circuit 122 outputs sound data to the speaker 29. Specifically, the CPU 106 reads sound data stored in the ROM 108 and transmits the sound data to the speaker driving circuit 122 through the I/O bus 104. Thus, predetermined sound effects are emitted from the speaker 29.

The hopper driving circuit 124 outputs a payout signal to the hopper 44 when a cash-out occurs. Specifically, when a cash-out signal is inputted from the cash-out switch 23, the CPU 106 outputs a driving signal to the hopper driving circuit 124 through the I/O bus 104. Thus, the hopper 44 pays out medals equivalent to the number of credits remaining at the time, which are stored in a predetermined memory region of the RAM 110.

The display controller 140a starts the slot games one by one or all at once in the slot game areas in which the slot games are activated, among the plurality of slot game areas A1 to A10 provided on the liquid crystal display 16. The CPU 106 generates an image display command signal corresponding to either an effect image representing that the symbols are scrolled and then stopped or an outcome of the slot game for each of the slot game areas, and outputs the image display command signal to the display controller 140a through the I/O bus 104. Upon receipt of the image display command signal outputted from the CPU 106, the display controller 140a generates a driving signal for driving the liquid crystal display 16 according to the image display command and outputs the generated driving signal to the liquid crystal display 16. Thus, a predetermined image is displayed on the liquid crystal display 16.

The display controller 140b performs control for executing a special slot game on the upper display 33. The CPU 106 generates an image display command signal corresponding to a progress of the special slot game and outputs the image display command signal to the display controller 140b through the I/O bus 104. Upon receipt of the image display command signal outputted from the CPU 106, the display controller 140b generates a driving signal for driving the upper display 33 according to the image display command and outputs the generated driving signal to the upper display 33. Thus, an image related to the special slot game is displayed on the upper display 33.

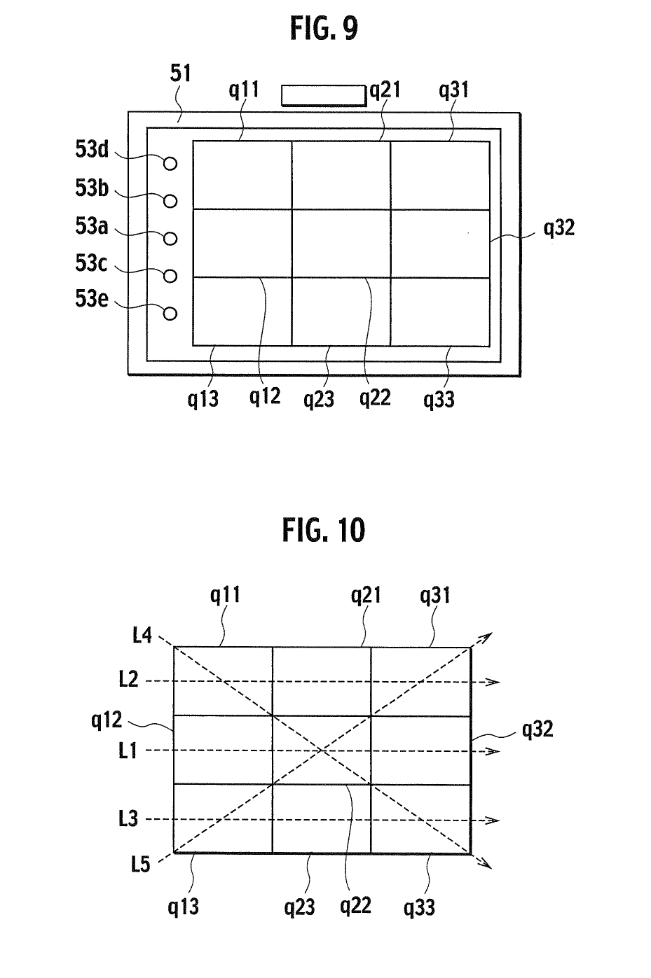

Next, with reference to FIG. 9, description will be given of an image displayed in each of the slot game areas A1 to A10. FIG. 9 shows a display example in each of the slot game areas A1 to A10.

As shown in FIG. 9, 3 rows×3 columns, a total of 9 display regions q11 to q33 are provided in each of the slot game areas A1 to A10. When a slot game is executed, various scrolling symbols are displayed in those nine display regions q11 to q33.

To the left of the display regions q11 to q33, five light emitting diodes (LEDs) 53a to 53e are provided. Which and how many LEDs to be turned on among the LEDs 53a to 53e is determined according to the number of bets. To be more specific, when a credit equivalent to 1 medal is bet on one of the slot game areas A1 to A10, the LED 53a is turned on in this slot game area. When credits equivalent to 2 medals are bet on one of the slot game areas A1 to A10, the LEDs 53b and 53c in addition to the LED 53a are turned on in this slot game area. When credits equivalent to 3 medals are bet in one of the slot game areas A1 to A10, the LEDs 53d and 53e in addition to the LEDs 53a to 53c are turned on in this slot game area.

The LEDs 53a to 53e are provided to notify respective paylines in each of the slot game areas A1 to A10. FIG. 10 is an explanatory view showing paylines in each of the slot game areas A1 to A10. In 3 rows×3 columns, a total of 9 display regions q11 to q33, it is assumed that a center horizontal line is L1, that an upper horizontal line is L2, that a lower horizontal line is L3, that a downward sloping line is L4 and that an upward sloping line is L5.

The line L1 is set as a payline when the LED 53a shown in FIG. 9 is turned on, the lines L2 and L3 are set as paylines when the LEDs 53b and 53c are turned on, and the lines L4 and L5 are set as paylines when the LEDs 53d and 53e are turned on. Accordingly, only the line L1 serves as a payline when a credit equivalent to 1 medal is bet, the lines L1 to L3 serve as paylines when credits equivalent to 2 medals are bet, and all the lines L1 to L5 serve as paylines when credits equivalent to 3 medals are bet. When the symbols are rearranged in a predetermined combination on any of these paylines set in the above-described manner, a payout corresponding to the combination is determined.

An activated area notifying frame 51 is provided around the display regions q11 to q33. When the slot game is activated in one of the slot game areas A1 to A10, the activated area notifying frame 51 is lighted up in this slot game area. When at least a credit equivalent to 1 medal is bet on one of the slot game areas A1 to A10, the activated area notifying frame 51 is lighted up in this slot game area. Thus, the player can easily recognize the activated slot game area among the ten slot game areas A1 to A10.

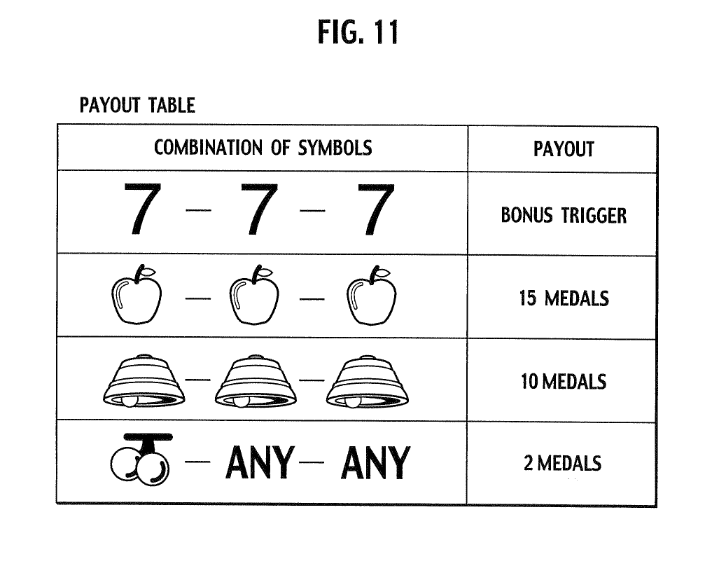

FIG. 11 is an explanatory view showing combinations of symbols leading to payouts. As shown in FIG. 11, if “7” symbols are lined up on a payline, in other words, if, for example, three “7” symbols are lined up on the line L1 when the line L1 shown in FIG. 10 is set as a payline, a bonus game is started. The bonus game means a game that provides a gaming state advantageous to the player, such as a state where a predetermined number of slot games can be executed without making bets, or that provides a special payout. Meanwhile, if “APPLE” symbols are lined up, a payout equivalent to 15 medals is determined. Likewise, if “BELL” symbols are lined up, a payout equivalent to 10 medals is determined, and if a “CHERRY” symbol is stopped on any of the display regions on the left side, a payout equivalent to 2 medals is determined.

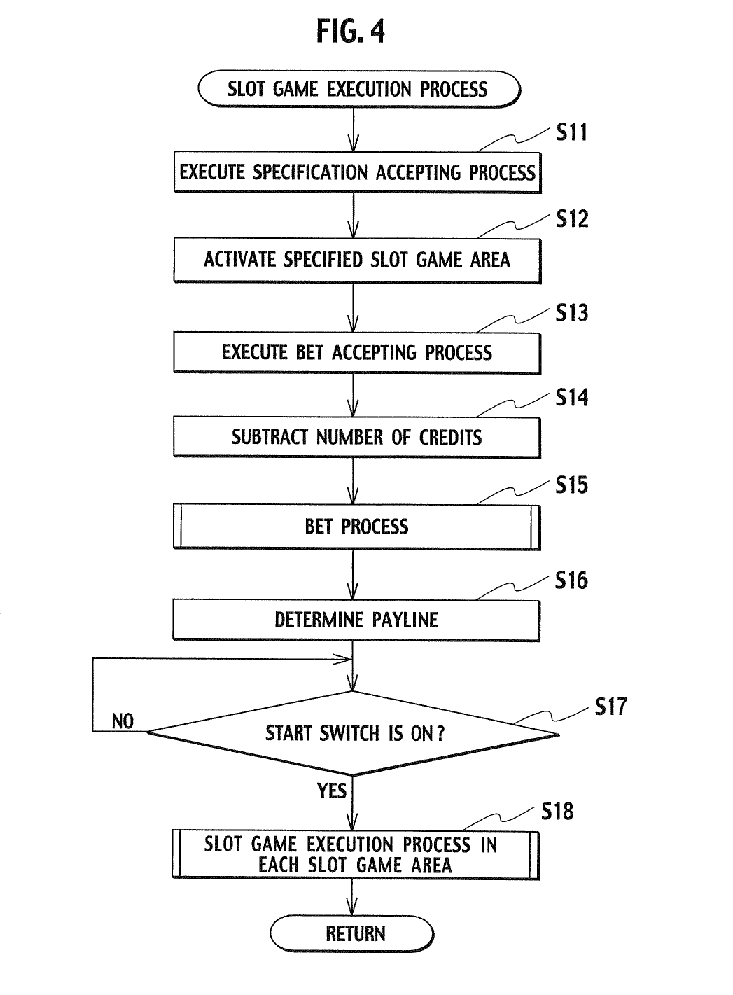

Next, with reference to flowcharts shown in FIGS. 4 to 8, operations of the slot machine according to this embodiment will be described. With reference to FIG. 4, description will be given of a slot game execution process carried out by the CPU 106 according to the game execution program stored in the ROM 108.

The CPU 106 performs a specification accepting process for accepting specification, by the player, of at least one of the slot game areas A1 to A10 to be activated (Step S11). In this specification accepting process, the CPU first determines, on the basis of a position detection signal from the touch panel 69, the slot game area touched by the player so as to be specified as a slot game area to be activated among the slot game areas A1 to A10. The CPU 106 then activates the specified one of the slot game areas A1 to A10 that is determined in the above-described manner as a slot game area in which a slot game is executed (Step S12). In the activated one of the slot game areas A1 to A10, the activated area notifying frame 51 provided in the peripheral portion of this slot game area is lighted up by the CPU 106. Thus, the activated one of the slot game areas A1 to A10 is notified to the player.

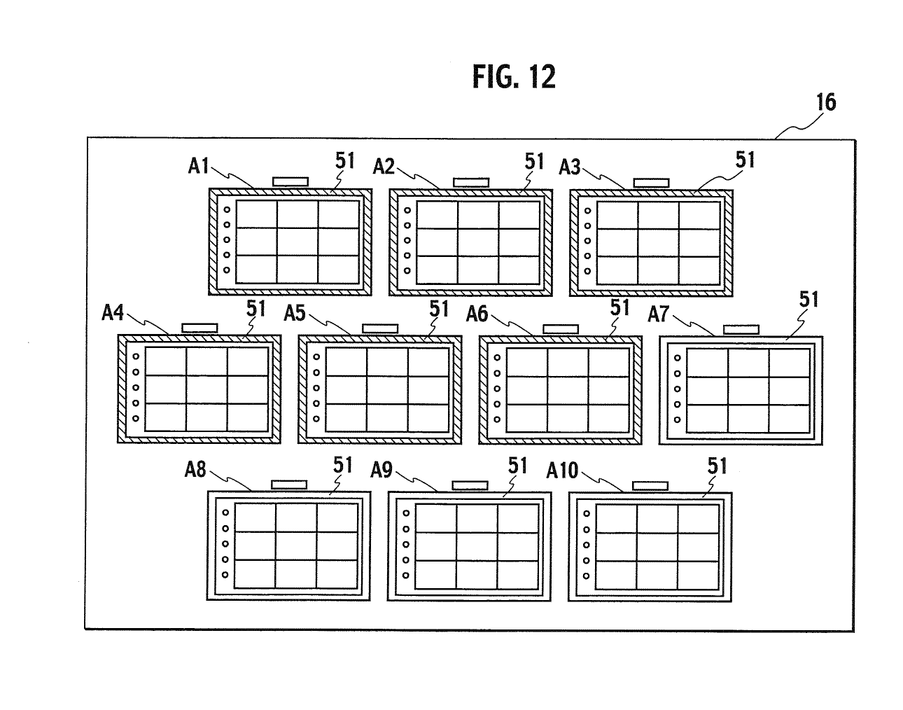

As an example of activation of the slot game areas, when the slot game areas A1 to A6, for example, are specified by the player, the activated area notifying frames 51 in the slot game areas A1 to A6 are lighted up as shown in FIG. 12, thereby indicating that the slot game areas A1 to A6 have been activated. Here, the slot game areas A7 to A10 which are not specified are not activated. Thus, none of the activated area notifying frames 51 in the slot game areas A7 to A10 is lighted up.

Next, the CPU 106 performs a bet accepting process for accepting credits bet on the activated one of the slot game areas A1 to A10 (Step S13). In this bet accepting process, the CPU determines the number of the bet credits by detecting an operation of pressing the BET switch 25 by the player. Thereafter, the CPU 106 subtracts the number of the bet credits from the number of current credits (Step S14). For example, if “30” credits are bet when the number of current credits is “50”, “30” credits are subtracted from “50” credits to leave “20” credits.

Note that credits can also be bet on the slot game in the activated one of the slot game areas A1 to A10 by inserting medals from the medal insertion slot 21 by the player. In this case, the CPU 106 recognizes the number of medals inserted from the medal insertion slot 21 by the player as the number of credits to be bet. When credits are bet by inserting medals from the medal insertion slot 21, it is not required to perform the subtraction of credits in Step S14.

Note that the process shown in FIG. 4 has been described by taking the case where the game areas to be activated can be specified by the player. However, the present invention may also be applied to a configuration in which a bet operation is previously performed by the player and thus arbitrary game areas are automatically selected and sequentially activated according to the number of bets.

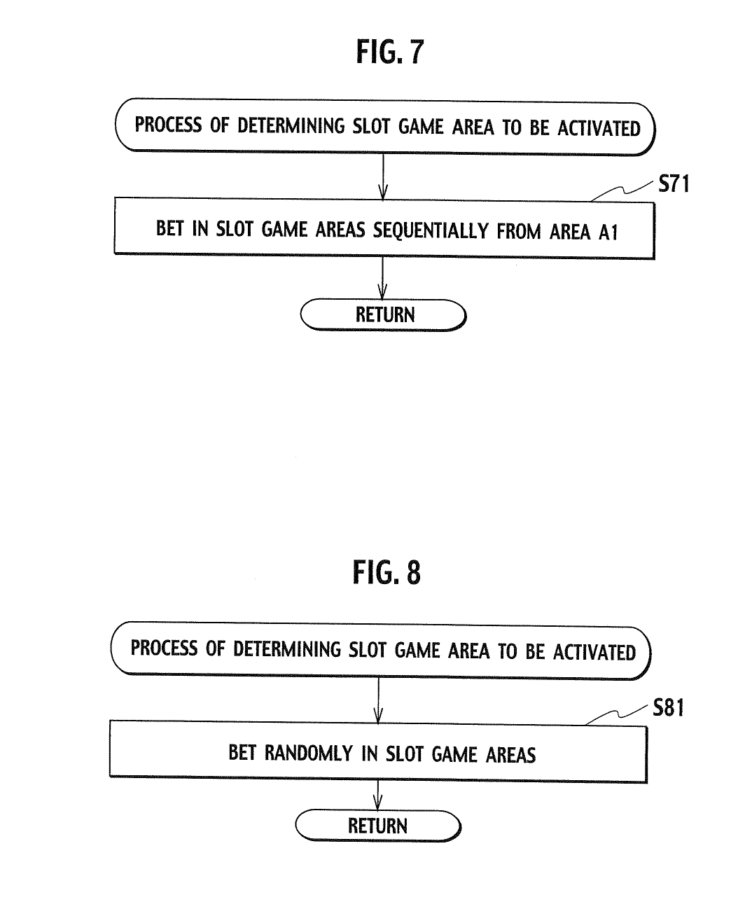

Next, the CPU 106 performs a bet process for betting credits on the slot games in the activated slot game areas A1 to A10 (Step S15). This process will be described in detail later with reference to FIGS. 7 and 8.

After completing the process of betting credits on the slot game in the activated one of the slot game areas A1 to A10, the CPU 106 determines at least one payline in the activated one of the slot game areas A1 to A10 according to the number of credits bet on the slot game in the activated one of the slot game areas A1 to A10 (Step S16). As described above, this process is performed as follows. Specifically, when a credit equivalent to 1 medal is bet on a slot game in one of the slot game areas A1 to A10, the line L1 shown in FIG. 10 is activated in this slot game area. When credits equivalent to 2 medals are bet on a slot game in one of the slot game areas A1 to A10, the lines L1 to L3 are activated in this slot game area. When credits equivalent to 3 medals are bet on a slot game in one of the slot game areas A1 to A10, all the lines L1 to L5 are activated in this slot game area.

Moreover, as described later, when credits are randomly bet on the slot games in the slot game areas A1 to A10 (see FIG. 8), it is not necessarily the case that the credits are bet in numerical order of the slot game areas A1 to A10. For example, in the case where the slot game areas A1, A3, A6, A8 and A10 are activated by the player in Step S11, there is performed a process in which the number of the bet credits are randomly allocated to the respective specified slot game areas. Specifically, first, a credit equivalent to 1 medal is allocated to the slot game in the slot game area A8. Next, a credit equivalent to 1 medal is allocated to the slot game in the slot game area A3. Thereafter, a credit equivalent to 1 medal is allocated to the slot game in the slot game area A10. Subsequently, a credit equivalent to 1 medal is allocated to the slot game in the slot game area A1. Finally, a credit equivalent to 1 medal is allocated to the slot game in the slot game area A6. A bet credit is randomly allocated to one of the slot game areas as described above every time a bet is repeated.

Here, with reference to the flowchart shown in FIG. 7, the bet process in Step S15 in the flowchart shown in FIG. 4 will be described. When the BET switch 25 is pressed or medals are inserted from the medal insertion slot 21, the CPU 106 first bets credits sequentially in ascending order of the slot game area number, A1, A2, A3 . . . , on the slot game areas activated by the process in Step S12 in the flowchart shown in FIG. 4 among the slot game areas A1 to A10 (Step S71).

Meanwhile, FIG. 8 is a flowchart showing another procedure of the bet process in Step S15 in the flowchart shown in FIG. 4. In this process, when the BET switch 25 is pressed, as in the case of FIG. 7, the CPU 106 first bets credits randomly on the slot game areas activated by the process in Step S12 in the flowchart shown in FIG. 4 among the slot game areas A1 to A10 (Step S81). In this event, the order of betting credits on the slot games in the slot game areas in which a bonus game is not being executed among the slot game areas A1 to A10 is arbitrarily determined by the CPU 106 and randomly determined for each game.

Thereafter, the CPU 106 determines whether or not the start switch 27 is turned on (Step S17). If the start switch 27 is turned on, the CPU 106 performs a series of processes for executing the slot games in the order either specified by the player or automatically selected, out of the activated ones of the slot game areas A1 to A10 (Step S18).

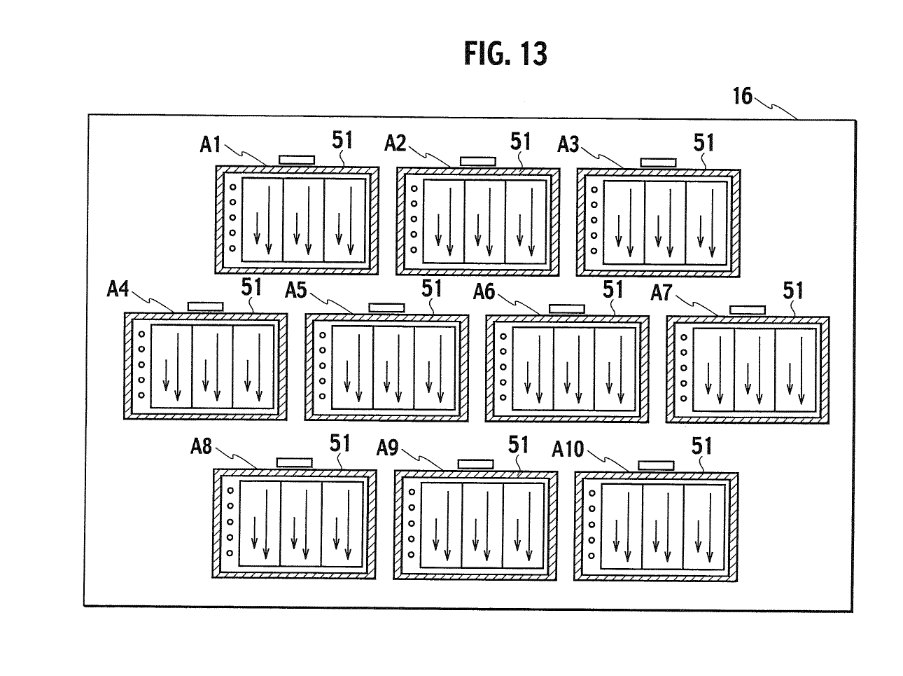

FIG. 13 shows a display screen example of the liquid crystal display 16 in the case where slot games are started in the activated ones of the slot game areas A1 to A10 when the start switch 27 is turned on. The display screen example shown in FIG. 13 indicates a state where all the slot game areas A1 to A10 are activated by the player and the slot games are started in all the slot game areas.

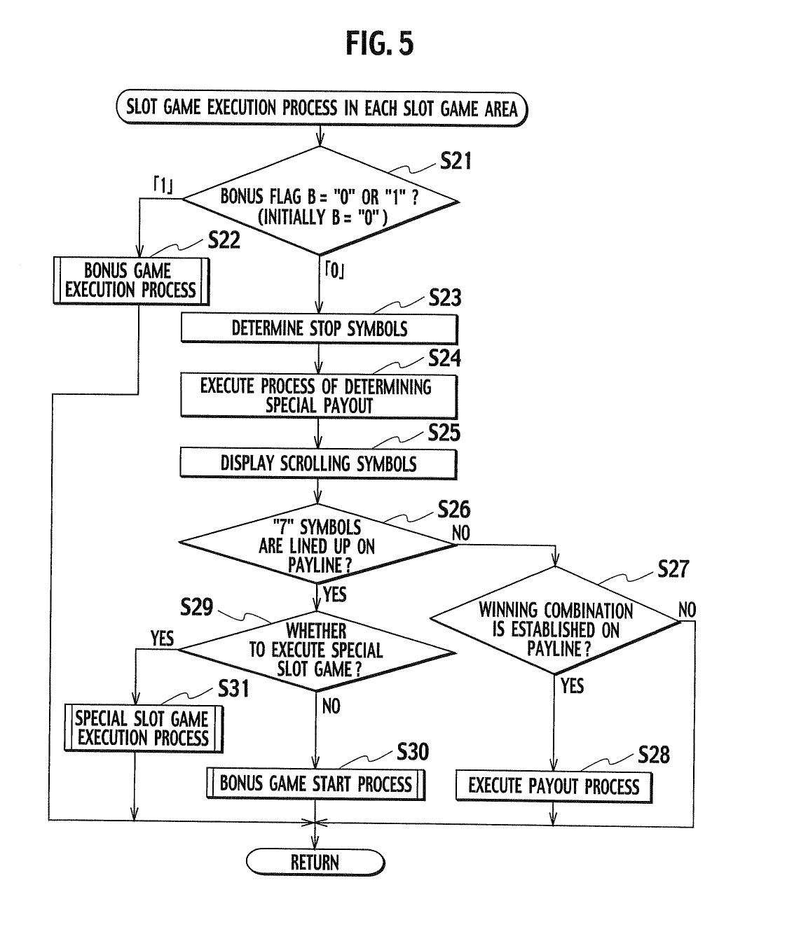

Next, with reference to FIG. 5, description will be given of a procedure of processing slot games executed in the specified (activated) ones of the slot game areas A1 to A10. Here, description will be given by taking, as an example, a slot game executed in the slot game area A5.

As described with reference to FIGS. 1A and 1B, the CPU 106 first determines whether a bonus flag is “0” or “1” in each of the activated ones of the slot game areas A1 to A10 (Step S21). The bonus flag is initially set to “0”, and becomes “1” when a bonus game is executed. In the next or subsequent games, when the bonus flag is “1”, a bonus game execution process is performed in Step S22.

Next, the CPU 106 determines which symbols to be stopped in the respective display regions q11 to q33 in the slot game area (Step S23). By this process, the symbols (“7”, “BELL”, “APPLE” and the like) to be displayed in the respective display regions q11 to q33 are determined.

Subsequently, the CPU 106 allows the random number generating circuit 112 to generate a random number and performs a process of determining whether to be the special payouts MINI, MAJOR or MEGA or a dummy (Step S24). The generated random number is stored in the RAM 110.

Thereafter, the CPU 106 scrolls the symbols in the display regions q11 to q33 in the slot game area (Step S25). After a predetermined period of time, symbols are stopped in the respective display regions q11 to q33. Here, the symbols determined in Step S23 are stopped to be displayed in the respective display regions.

Subsequently, the CPU 106 determines whether or not “7” symbols are lined up on a payline, the combination indicating a bonus trigger (Step S26). For example, when all of the five lines L1 to L5 shown in FIG. 10 are set as paylines, the CPU 106 determines whether or not the “7” symbols are lined up on any one of those paylines L1 to L5.

When the “7” symbols are not lined up on any if those paylines, the CPU 106 determines whether or not another combination that can provide a payout is established on any of those paylines (Step S27). If such a combination of symbols is established, a payout in an amount corresponding to the combination is determined (Step S28). When a predetermined combination is not established on any of the paylines, the CPU 106 determines no payout and finishes the slot game in the slot game area. Note that the bonus trigger is established when the “7” symbols are lined up on any one of the paylines L1 to L5.

Subsequently, the CPU 106 determines whether or not to execute a special slot game (Step S29). If no special payout is determined in Step S24, the CPU 106 executes a bonus game start process (Step S30). The bonus game means a game that provides a gaming state advantageous to the player, such as a state where a predetermined number of slot games can be executed without making bets by the player, or that provides a special payout. When the “7” symbols are lined up on any of the paylines to establish the bonus trigger, the CPU 106 sets the bonus flag to “1”. Thereafter, the CPU 106 determines the number of bonus games T. For example, the number of bonus games T may be determined to be a constant number of games, such as 50, or may be randomly determined by the CPU 106 in each case. The number of bonus games T is stored in the RAM 110. The player can make bets without losing credits during the determined number of bonus games. Note that, in the case of determining a payout, the medals equivalent to the payout may be paid out from the medal payout opening 28 or credits equivalent to the payout may be added to the current credits.

Meanwhile, when it is determined in Step S29 that the special payout is determined, the special slot game is executed (Step S31).

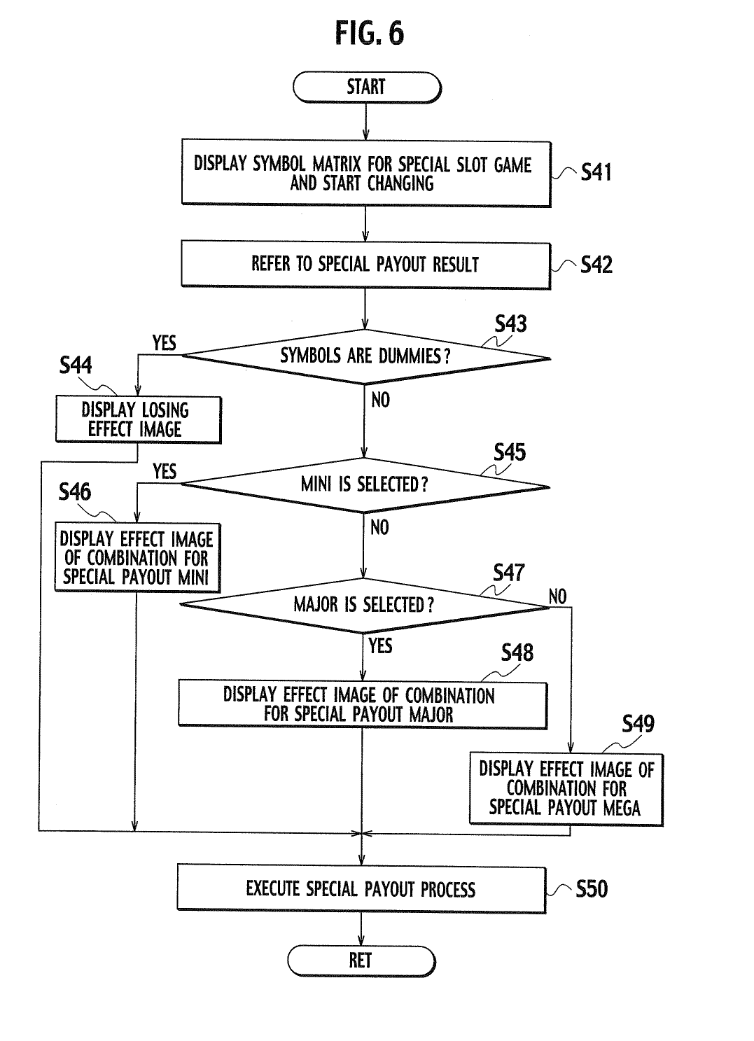

With reference to FIG. 6, description will be given of operations of the CPU 106 in the special slot game described above. When it is determined that the special payout is determined, the CPU 106 displays on the upper display 33 the symbol matrix for a special slot game and starts scrolling the symbols (Step S41). The CPU 106 subsequently refers to the outcome of the special payout temporarily stored in the RAM 110 or the like (Step S42) and first determines whether or not a combination of the symbols is that leading to no payout, in other words, a dummy (Step S43). If the combination of the symbols is the dummy (Step S43: Yes), an effect image indicating that the game is lost is displayed (Step S44).

Next, the CPU 106 determines whether or not the special payout “MINI” is selected (Step S45). When it is determined that the special payout “MINI” is selected, a combination leading to the special payout (in this embodiment, a combination of “MINI” symbols) is displayed in the symbol matrix on the upper display 33 (Step S46).

Subsequently, the CPU 106 determines whether or not the special payout “MAJOR” is selected (Step S47). When it is determined that the special payout “MAJOR” is selected, a combination leading to the special payout (in this embodiment, a combination of “MAJOR” symbols) is displayed in the symbol matrix on the upper display 33 (Step S48).

When it is determined that the special payout “MEGA” is selected (Step S47: No), the CPU 106 displays a combination leading to the special payout (in this embodiment, a combination of “MEGA” symbols) in the symbol matrix on the upper display 33 (Step S49).

Thereafter, the CPU 106 provides the special payout established in the special slot game (Step S50).

The operations of the slot machine 10 shown in FIGS. 4 and 5 described above will be concretely described below by use of display screen examples.

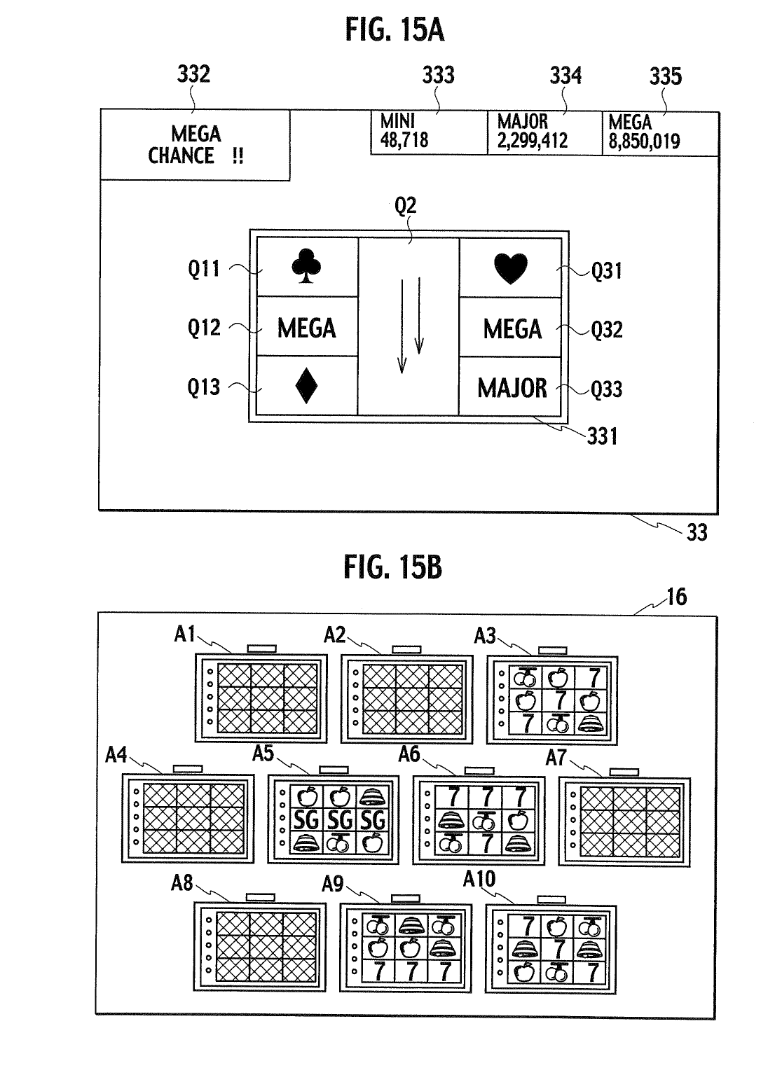

When all the slot game areas A1 to A10 displayed on the liquid crystal display 16 are specified by the player and the slot games are executed, the symbols are rearranged in the respective slot game areas as in the display screen example shown in FIG. 13. In the slot machine 10, an arrangement of the symbols to be stopped in each of the slot game areas and execution of the special slot game (any one of the three kinds or a dummy) are determined in Steps S23 and S24 shown in FIG. 5. Accordingly, an effect image is displayed based on the above determination. When the special slot game is executed, SG symbols are horizontally arranged in the slot game area A5 as shown in FIG. 15B in this embodiment.

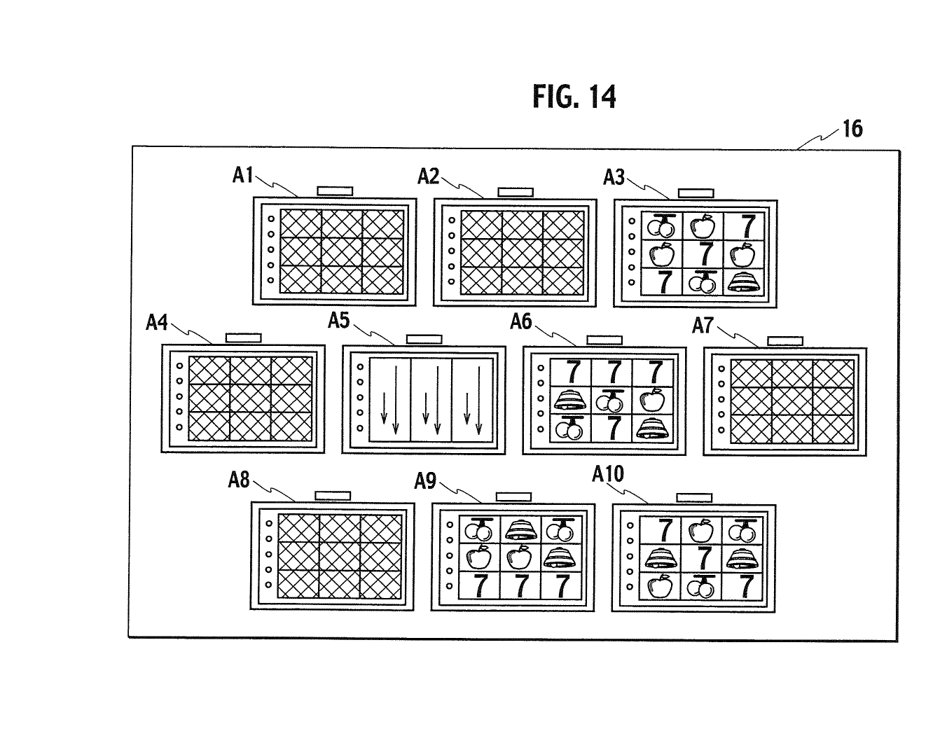

FIG. 14 shows a display screen example at a few seconds after the state shown in FIG. 13. FIG. 14 shows a state where rearrangements of the symbols are completed in all the slot game areas except the slot game area A5. Note that the shaded areas represent that no combination of symbols leading to a payout is established. In each of the areas in which payouts are determined (A3, A6, A9 and A10), the credits in the predetermined proportion described above are extracted and accumulated for a special payout.

It is assumed that the state shown in FIGS. 1A and 1B is obtained as an outcome of a rearrangement of the symbols in the slot game area A5 after another few seconds. In this event, in the slot machine 10, a special slot game is started by the processes in Steps S29 to S31 shown in FIG. 5. For example, if it is determined in Step S24 shown in FIG. 5 that the special payout MEGA is to be provided, the CPU 106 performs the processes in Steps S43 to S49 to display an effect image corresponding to the special payout determined in Step S24. Here, to be more specific, the components are controlled so as to display “MEGA” symbols on the horizontal line of display regions Q12, Q22 and Q32 in the special slot display part 331 on the upper display 33 (Step S49 in FIG. 6).

FIG. 15A shows a display example when the special slot game is being executed. The symbols are being scrolled in a display region Q2 and a character image “MEGA Chance!!” is displayed in the message display part 332. A CLUB symbol is displayed in a display region Q11, a MEGA symbol is displayed in a display region Q12, a DIAMOND symbol is displayed in a display region Q13, a HEART symbol is displayed in a display region Q31, a MEGA symbol is displayed in a display region Q32, and a MAJOR symbol is displayed in a display region Q33. Note that, in the special slot game in this embodiment, SPADE, HEART, DIAMOND and CLUB symbols are prepared besides the “MINI”, “MAJOR” and “MEGA” symbols. These symbols are rotated like reels and scroll-displayed in the display regions.

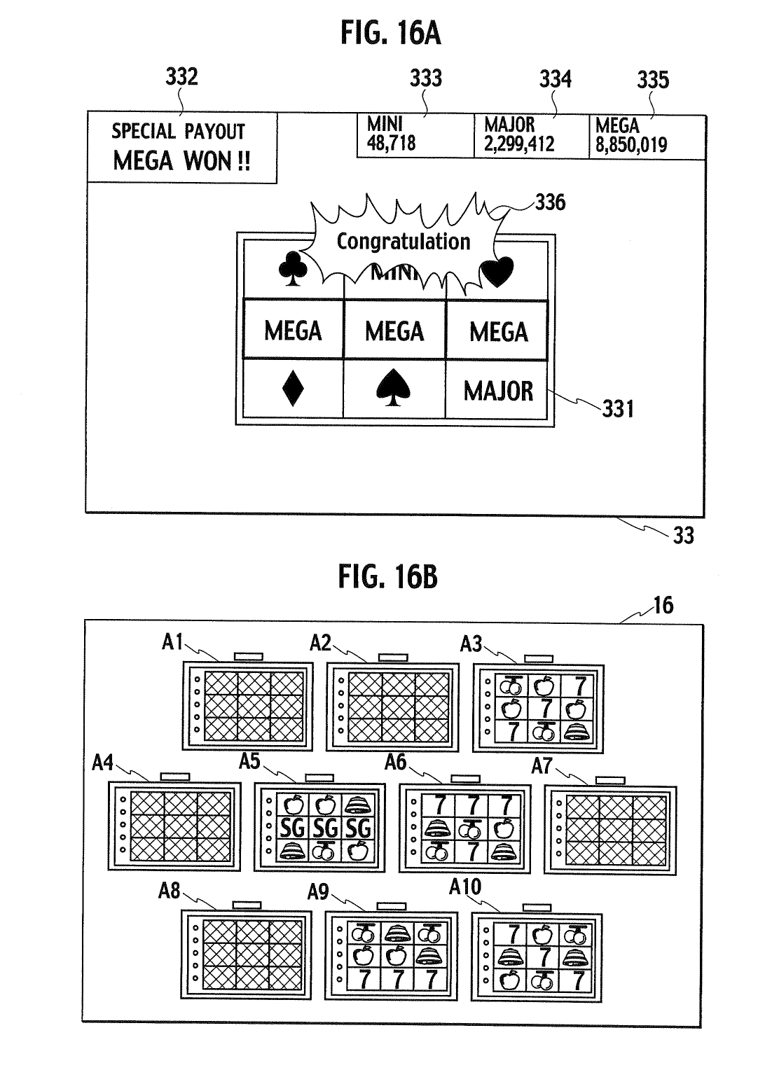

FIG. 16A shows a display screen example on the upper display 33 when a special payout MEGA is determined as an outcome of the special slot game. On the upper display 33, a character image 336 “Congratulation” is displayed. Moreover, in the message display part 332, a character string “Special Payout MEGA Won!!” is displayed. When the special payout MEGA is won, the number of credits displayed in the MEGA display part 335 is paid out.

As described above, the slot machine 10 includes the slot game areas A1 to A10 (10 at a maximum) in each of which a slot game can be individually played. By betting medals on two or more slot games in the respective slot game areas A1 to A10, the player can simultaneously play, in one play session, the two or more slot games in the slot game areas on which the medals are bet. In other words, a plurality of slot games can be played in one game machine. In this event, the slot games are executed respectively in the activated ones of the slot game areas A1 to A10 on the liquid crystal display 16. When at least one combination of symbols leading to a payout is established as an outcome of each of the slot games, some of the credits to be paid out are accumulated as a special payout. Thereafter, a special slot game is provided when a predetermined condition is met, and a special payout is provided when a combination of specific symbols is established as an outcome of the special slot game. Thus, it is possible to allow the player to have expectations for the special slot game executed on the upper display 33. Moreover, it is possible to provide new entertainment properties and also to allow the player to further focus on the slot game.

Note that, in the above example, credits are bet on at least one of the slot game areas A1 to A10 by inserting in medals. However, credits may be bet by use of coins, bills, bar-coded tickets and the like other than the medals. Moreover, the description was given by taking, as an example, the case where, in each slot game, stopped symbols are scrolled and the symbols are subsequently stopped again. However, the slot game is not limited to the case of scrolling the symbols. For example, the slot machine according to the present invention may have a configuration in which the symbols displayed (arranged) in the respective display regions are individually changed and new symbols are displayed (rearranged). Furthermore, in the above example, the maximum number of credits that can be bet on the respective slot game areas A1 to A10 is set to 3. However, the present invention is not limited thereto.

The slot machine according to the embodiment of the present invention has been described above. However, the invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein. In this embodiment, one kind of character image, the frog character image X is used, for example, as the dynamic character image X that is the predetermined character image. However, several kinds of character images may be used as predetermined character images and simultaneously displayed. In such a case, in addition to setting of payouts in this embodiment, setting of payouts according to the kinds of the predetermined character images may be executed. Specifically, a payout amount may be set to vary according to the kinds of the predetermined character images.

Moreover, the effects described in the embodiment of the present invention are only a list of optimum effects achieved by the present invention. Hence, the effects of the present invention are not limited to those described in the embodiment of the present invention.

What is claimed is:

1. A slot machine comprising:
a display adapted to display a plurality of symbol matrices including a plurality of symbols arranged in the symbol matrices; and
a controller configured to
execute a slot game in each of the plurality of symbol matrices, the slot game in which whether credits are to be paid out or not is determined according to an arrangement determined by rearranging the plurality of symbols arranged in the symbol matrix,
accumulate, as special credits, some of the credits to be paid out when a payout of credits is determined in the slot game,
start a special slot game for paying out the special credits at a predetermined timing, and
pay out the special credits when an arrangement of the symbols leading to a payout of the special credits is established in the special slot game.

2. A slot machine comprising:
a display adapted to display a plurality of symbol matrices including a plurality of symbols arranged in the symbol matrices; and
a controller configured to
execute a slot game in each of the plurality of symbol matrices, the slot game in which whether credits are to be paid out or not is determined according to an arrangement determined by rearranging the plurality of symbols arranged in the symbol matrix,
accumulate, as special credits, some of the credits to be paid out when a payout of credits is determined in the slot game,
start a special slot game for paying out the special credits at a predetermined timing,
pay out the special credits when an arrangement of the symbols leading to a payout of the special credits is established in the special slot game, and
carry the special credits over into the next-occurring special slot game, when the arrangement of the symbols leading to a payout of the special credits is not established in the current special slot game.

3. A slot machine comprising:
a display adapted to display a plurality of symbol matrices including a plurality of symbols arranged in the symbol matrices; and
a controller configured to
execute a slot game in each of the plurality of symbol matrices, the slot game in which whether credits are to be paid out or not is determined according to an arrangement determined by rearranging the plurality of symbols arranged in the symbol matrix,
accumulate, as special credits, some of the credits to be paid out when a payout of credits is determined in the slot game,
start a special slot game for paying out the special credits at a predetermined timing,
pay out the special credits when an arrangement of the symbols leading to a payout of the special credits is established in the special slot game, and
display a total number of the special credits on the display when the special slot game is started.

4. The slot machine according to claim 1, wherein the controller is configured to start the special slot game when the symbols are rearranged in a specific combination in the symbol matrix in which the last slot game is executed, among the plurality of symbol matrices.

5. A method for controlling a slot machine, comprising the steps of:
executing a slot game in each of a plurality of symbol matrices, the slot game in which whether credits are to be paid out or not is determined according to an arrangement determined by rearranging the plurality of symbols arranged in the symbol matrix;
accumulating, as special credits, some of the credits to be paid out when a payout of credits is determined in the slot game,
starting a special slot game for paying out the special credits at a predetermined timing, and
paying out the special credits when an arrangement of the symbols leading to a payout of the special credits is established in the special slot game.

6. A method for controlling a slot machine, comprising the steps of:
executing a slot game in each of a plurality of symbol matrices, the slot game in which whether credits are to be paid out or not is determined according to an arrangement determined by rearranging the plurality of symbols arranged in the symbol matrix;
accumulating, as special credits, some of the credits to be paid out when a payout of credits is determined in the slot game,
starting a special slot game for paying out the special credits at a predetermined timing,
paying out the special credits when an arrangement of the symbols leading to a payout of the special credits is established in the special slot game, and
carrying the special credits over into the next-occuring special slot game, when the arrangement of the symbols leading to a payout of the special credits is not established in the current special slot game.

7. A method for controlling a slot machine, comprising the steps of:
executing a slot game in each of a plurality of symbol matrices, the slot game in which whether credits are to be paid out or not is determined according to an arrangement determined by rearranging the plurality of symbols arranged in the symbol matrix;
accumulating, as special credits, some of the credits to be paid out when a payout of credits is determined in the slot game,
starting a special slot game for paying out the special credits at a predetermined timing,
displaying a total number of the special credits on the display when the special slot game is started, and
paying out the special credits when an arrangement of the symbols leading to a payout of the special credits is established in the special slot game.

8. The method for controlling a slot machine according to claim 5, the method further comprising the step of:
starting the special slot game when the symbols are rearranged in a specific combination in the symbol matrix in which the last slot game is executed, among the plurality of symbol matrices.
